(19) United States
(12) Patent Application Publication
(10) Pub. No.: US 2022/0391716 A1
(43) Pub. Date: Dec. 8, 2022

(54) LITHOLOGY PREDICTION IN SEISMIC DATA

(71) Applicant: Landmark Graphics Corporation, Houston, TX (US)

(72) Inventors: Andrew Davies, Abingdon (GB); Graham Baines, Abingdon (GB); Alejandro Alberto Jaramillo, Edinburgh (GB); Yikuo Liu, Edinburgh (GB); Olutobi Adeyemi, Didcot (GB)

(21) Appl. No.: 17/775,460

(22) PCT Filed: Jan. 23, 2020
(86) PCT No.: PCT/US2020/014803

§ 371 Date: May 9, 2022

Related U.S. Application Data
(60) Provisional application No. 62/944,762, filed on Dec. 6, 2019.

(51) Int. Cl. G06N 5/02; G01V 1/50

(52) U.S. Cl. CPC G06N 5/022; G01V 1/50; G01V 2210/66

(57) ABSTRACT

A lithology prediction that uses a geological age model as an input to a machine learning model. The geological age model is capable of separating and recoding different seismic packages derived from the horizon interpretation. Once the machine learning model has been trained, a validation may be performed to determine the quality of the machine learning model. The quality may be improved by refining the training of the machine learning model. The lithology prediction generated by the machine learning model that utilizes the geological age model provides an improved lithology prediction that more accurately reflects the subterranean formation of an area of interest.

### CROSS-REFERENCE TO RELATED APPLICATION

The present application claims the benefit of U.S. Provisional Application No. 62/944,762; filed Dec. 6, 2019, which is incorporated herein by reference in its entirety for all purposes.

### TECHNICAL FIELD

The present application relates generally to lithology prediction, and more particularly to a mechanism to predict lithology throughout an entire seismic volume using a combination of seismic data, age modelling and well data.

### BACKGROUND

In hydrocarbon exploration and production, seismic energy may be generated and transmitted into subterranean formations of an area of interest. Seismic waves may be reflected or refracted off the subterranean formations and recoded by acoustic receivers positioned on the Earth's surface or seafloor, on the surface of a body of water (for example, a sea, ocean or lake), suspended vertically in the body of water or within a wellbore. The seismic waves reflected from the subterranean formations may be sampled as seismic data and used to provide information on subterranean formations including properties or characteristics of the subterranean formations in the area of interest.

The interpretation of seismic data associated with the subterranean formations underpins exploration and production workflows. Across these workflows, seismic attributes are analyzed to discern seismic facies, and by proxy lithology, utilizing information from wells tied to the post-stack seismic volume where such information is available. Understanding of lithology of the subterranean formations assists in many aspects, including the creation of accurate velocity models, assessing hydrocarbon prospectivity, generating reservoir models and well plans. However, seismic data alone cannot provide an unequivocal determination of lithology. A robust mechanism is needed to provide a more accurate prediction of lithology throughout an entire seismic volume associated with a subterranean formation within an area of interest.

### BRIEF DESCRIPTION OF THE DRAWINGS

FIG. 1A illustrates a partial cross-sectional schematic diagram of a wellbore environment for acquiring data for use in a lithology prediction using a machine learning model for a subterranean formation of interest, according to one or more aspects of the present disclosure.

FIG. 1B illustrates a partial cross-sectional schematic diagram of an wireline system for acquiring data for use in a lithology prediction using a machine learning model for a subterranean formation of interest, according to one or more aspects of the present disclosure.

FIG. 1C illustrates a schematic partial cutaway view of a wellbore environment for acquiring data for use in a lithology prediction using a machine learning model, according to one or more aspects of the present disclosure.

FIG. 2 illustrates a cross-plot of data associated with a subterranean formation and a corresponding lithology prediction.

FIG. 3A illustrates seismic horizons associated with a post-stack seismic reflection volume, according to one or more aspects of the present disclosure.

FIG. 3B illustrates a geophysical age modelling applied to the seismic horizons of FIG. 3A, according to one or more aspects of the present disclosure.

FIG. 4 illustrates a schematic diagram of an information handling system for a well system, according to one or more aspects of the present disclosure.

FIG. 5 illustrates a flow chart for lithology prediction using a geological age model, according to one or more aspects of the present disclosure.

FIG. 6A illustrates a lithology prediction.

FIG. 6B illustrates a cross-plot of data associated with a subterranean formation and a lithology prediction using a geological age model, according to one or more aspects of the present disclosure.

FIG. 6C illustrates a comparison of the lithology predictions, according to one or more aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present application relates to a robust mechanism for accurately predicting lithology of a subterranean formation in an area of interest. Accurate prediction of lithology increases efficiency, conserves resources and reduces costs and expenditures required for selecting and drilling a well. For example, an accurate prediction of lithology may improve the exploration for, production from and storage within a water reservoir, a hydrocarbon reservoir, a fluid (including a gas or liquid) and any other type of reservoir.

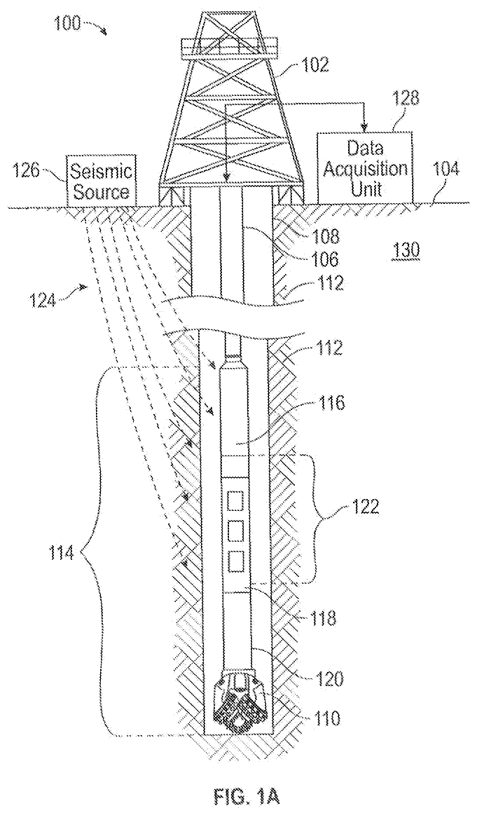

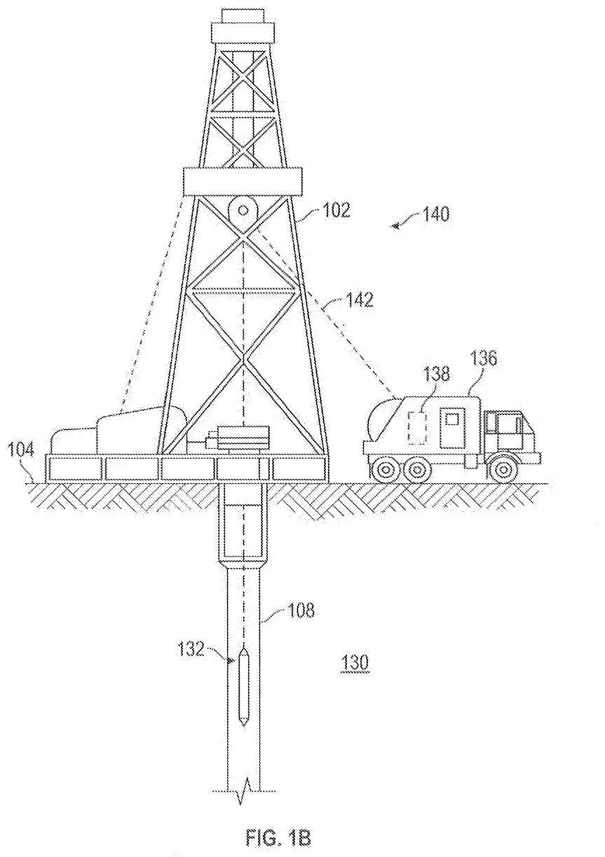

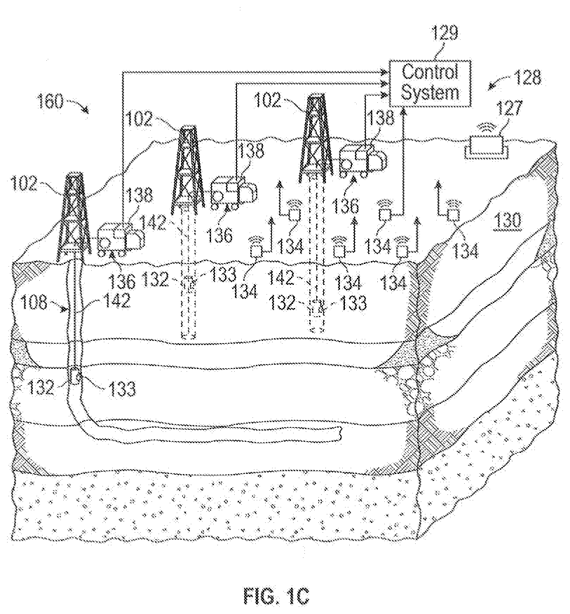

Seismic reflection data are routinely used to predict characteristics or properties of a subterranean formation in an area of interest. Seismic reflection data includes, but is not limited to, amplitude of the seismic signal as a function of two-way travel time (TWT), or depth, and other seismic attributes derived from it such as instantaneous phase, instantaneous frequency, instantaneous power, analytic signal, AVO (amplitude versus offset) attributes, coherence, impedance, similarity, discontinuity, sweetness, curvature and continuous wavelet transform. Tying lithological interpretations from a well, such as wellbore 108 of FIGS. 1A and 1B, in the area of interest to 2-D (two dimensional), 3-D (three dimensional) or 4-D (four dimensional) seismic reflection data associated with a post-stack seismic reflection volume or section provides information that may be used to train a supervised machine learning algorithm such that the seismic character of one or more different lithologies of a subterranean formation within the area of interest is determined. Determining the seismic character in this way results in a noisy, and stratigraphically un-realistic lithology prediction. Incorporating a geophysical age model for a post-stack seismic reflection volume into the training of the machine learning algorithm improves the accuracy of the lithology prediction of the subterranean formation throughout a post-stack seismic reflection volume within the area of interest, reducing noise. Using a geophysical age model also generates realistic geological bodies, for example, parasequences and progradation trends. Such accuracy in lithology prediction provides a better understanding of subterranean formations which aids in the determination of where, if at all, to locate a wellsite, for example, for maximum production and storage within a formation of a hydrocarbon, water, or any other fluid (including a liquid or gas) or rock type. Further, such accuracy in lithology prediction may also provide a better understanding of the risks associated with a selected wellsite, for example, pressures associated with the subterranean formation and required cements or other fluids necessary to effectuate a production or storage of a fluid or rock type. A lithology prediction that incorporates a geophysical age model provides an improvement over known techniques that use a statistical approach based purely on data implicit within post-stack seismic reflection volumes.

In one or more embodiments of the present disclosure, an environment may utilize an information handling system to control, receive information or data from, manage or otherwise operate one or more operations, sensors, devices, components, networks, any other type of system or any combination thereof. For purposes of this disclosure, an information handling system may include any instrumentality or aggregate of instrumentalities that are configured to or are operable to compute, classify, process, transmit, receive, retrieve, originate, switch, store, display, manifest, detect, record, reproduce, handle, or utilize any form of information, intelligence, or data for any purpose, for example, for operation of equipment at a wellsite or a maritime vessel. In one or more embodiments, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. The information handling system may also include one or more interface units capable of transmitting one or more signals to a controller, sensor, actuator, or like device.

For the purposes of this disclosure, computer-readable media may include any instrumentality or aggregation of instrumentalities that may retain data, instructions or both for a period of time. Computer-readable media may include, for example, without limitation, storage media such as a sequential access storage device (for example, a tape drive), direct access storage device (for example, a hard disk drive or floppy disk drive), compact disk (CD), CD read-only memory (ROM) or CD-ROM, DVD, RAM, ROM, electrically erasable programmable read-only memory (EEPROM), and/or flash memory, biological memory, molecular or deoxyribonucleic acid (DNA) memory as well as communications media such wires, optical fibers, microwaves, radio waves, and other electromagnetic and/or optical carriers; and/or any combination of the foregoing.

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present invention, the following examples of certain embodiments are given. In no way should the following examples be read to limit, or define, the scope of the invention. Embodiments of the present disclosure may be applicable to horizontal, vertical, deviated, or otherwise nonlinear wellbores in any type of subterranean formation. Embodiments may be applicable to injection wells as well as production wells, including hydrocarbon wells.

Various aspects of the present disclosure may be implemented in various environments. FIG. 1A is a cross-sectional schematic diagram of a wellbore environment that may be used for acquiring seismic data, well log data, well core date or any combination thereof for use in lithology prediction using a machine learning model or multivariate model, according to one or more aspects of the present disclosure. While FIG. 1A illustrates a land-based wellbore environment, the present invention contemplates any type of environment including a subsea environment. In one or more embodiments, seismic data may be collected over a period of time for an area of interest that intersects or encompasses a wellbore environment and stored in a memory of an information handling system for use at a later time. In one or more embodiments, the post-stack seismic reflection volume may be unrelated to the collection of well log data. In one or more embodiments, the seismic data may be collected along with the collection of well log data. An example wellbore environment 100 for acquiring seismic data, well log data or both according to one or more aspects of the present disclosure is illustrated. The wellbore environment 100 includes a derrick 102 positioned at a surface 104. The derrick 102 may support components of the wellbore environment 100, including a drill bit 110 coupled to a drill string 106 that extends below the surface 104 in a wellbore 108.

The drill string 106 may comprise one or more downhole tools, for example, a bottom hole assembly 114, positioned on the drill string 106 uphole of the drill bit 110. The bottom hole assembly 114 includes a combination of various components, such as one or more drill collars 116, a downhole data collection tool 118, and a downhole motor assembly 120 for housing a motor for the drill bit 110. In one or more embodiments, the downhole data collection tool 118 may include an array of sensors 122, such as seismic sensors (for example, geophones), or the sensors 122 may engage with a wall of the wellbore 108. The sensors 122 may operate in response to one or more seismic waves 124 generated by a seismic source 126 positioned at the surface 104 proximate to the wellbore 108. The seismic source 126 may generate seismic energy to form the seismic waves 124 that may be transmitted from the surface 104 through the formation 112 adjacent to the wellbore 108 of the formation 130. Seismic source 126 may comprise, but is not limited to, any one or more of an air gun, a plasma sound source, a weight-drop truck, one or more explosive devices, an electromagnetic pulse (EMP) energy source, and a seismic vibrator. One or more seismic waves 124 generated by the seismic source 126 may be reflected or refracted by the formation 112 or 130 and sampled by any one or more of the one or more sensors 122 positioned or disposed on or about the downhole data collection tool 118.

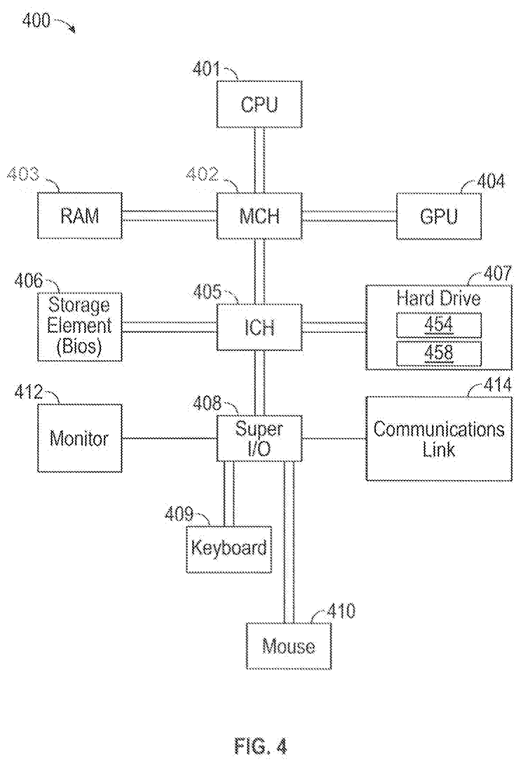

The data acquisition unit 128 may receive data from any one or more of the one or more sensors 122 of downhole data collection tool 118 and store the data in a storage device, for example, storage device 406 or 407 of FIG. 4. Storage device 406 or 407 may include but is not limited to a database, RAM, hard disk drive, optical drive, or any other non-transient storage medium. The storage device 407 may store the data generated from the downhole data collection tool 118 as data 454 of FIG. 4. In one or more embodiments, the data 454 may include raw information from one or more sensors 122 of the downhole data collection tool 118. In one or more embodiments, the downhole data collection tool 118 or an intermediate device between the downhole data collection tool 118 and the data acquisition unit 128 may include a processor or an information handling system (such as an information handling system 400 of FIG. 4) for processing any one or more portions of the sample information prior to transmitting the sample information to the data acquisition unit 128 for storage as data 454.

The data or information received by the one or more sensors 122 of the downhole data collection tool 118 may be recorded and used by a data acquisition unit 128 at the surface 104 to acquire seismic data to provide information or data about one or more properties or characteristics of the formation 130. In one or more embodiments, the one or more sensors 122 may be configured to sample the seismic waves 124 reflected or refracted from the formation 130 at predetermined intervals of time. In one or more embodiments, the seismic source 126 may be configured to generate and transmit the one or more seismic waves 124 at the predetermined time intervals. In one or more embodiments, the data 454 may be generated by the sensors 122 and stored in the data acquisition unit 128 once a week, a month, a quarter, a year or any other interval of time. In one or more embodiments, the downhole data collection tool 118 may record vertical seismic profiling survey data and well log data. In one or more embodiments, any surface seismic data recorded by any one or more downhole data collection tool 118 may occur prior to erecting derrick 102 or prior to any drilling at wellbore environment 100.

The well data collected by the one or more sensors 122 may comprise logging while drilling (“LWD”) data and measurement-while drilling (“MWD”) data. In LWD, data is typically collected during the drilling process, thereby avoiding any need to remove the drilling assembly to insert a wireline logging tool. LWD consequently allows the drilling operator to make accurate real-time modifications or corrections to optimize performance while minimizing down time. MWD is the term for measuring conditions downhole concerning the movement and location of the drilling assembly while the drilling continues. LWD concentrates more on formation parameter measurement. While distinctions between MWD and LWD may exist, the MWD data, the LWD data or both may be collected for purposes of predicting the lithology of a subterranean formation of an area of interest. In one or more embodiment, the subterranean formation of the area of interest may be the subterranean formation 130.

In one or more embodiments, one or more samples received by the seismic sensors 122 may be stored in a storage device or memory positioned downhole, for example, in a bottom hole assembly 114. The one or more samples may be retrieved for analysis by a data acquisition unit 128 while downhole or for example, after retrieval of the bottom hole assembly 114. In one or embodiments, seismic tool 118 may be communicatively coupled to the data acquisition unit 128 by any suitable device or mechanism including, but not limited to, wired, wireless, fiber optic, telemetry, any other communication device or mechanism or any combination thereof. While only one data acquisition unit 128 is shown, the wellbore environment 100 may include any number of devices or tools for acquiring information or data from the seismic tool 118, such as one or more information handling systems. In one or more embodiments, any one or more devices or components illustrated as positioned on the surface 104 (for example, the seismic source 126 and the data acquisition unit 128) and any one or more of these devices illustrated downhole as positioned downhole in the wellbore 108 (for example, in seismic tool 118) may be positioned at the surface 104, within the wellbore 108 or any combination of at the surface 104 or within the wellbore 108.

FIG. 1B depicts a partial cross-sectional schematic diagram of a wireline system 140 for acquiring data for use in a lithology prediction using a machine learning model, according to one or more embodiments. At various times before, during, or after one or more treatments or other wellsite operations, data may be collected for a subterranean formation 130. While FIG. 1A illustrates a land-based wireline system, the present invention contemplates a subsea environment. In one or more embodiments, the wellbore tools extending into a wellbore 108 (for example, a work string for perforating the formation 130) may be removed from a wellbore 108 to conduct measurement/logging operations. As illustrated, the wireline system 140 may include a one or more wireline tools 132 that may be suspended into the wellbore 108 by a cable 142. The one or more wireline tools 132 may be communicably coupled to the cable 142. The cable 142 may include conductors for transporting power to the one or more wireline tools 132 and also facilitate communication between the surface 104 and the one or more wireline tools 132. A logging facility 136, shown in FIG. 1B as a truck, may collect measurements from the one or more wireline tools 132, and may include computing facilities 138 for controlling, processing, storing, and/or visualizing the measurements gathered by the one or more wireline tools 132. The computing facilities 138 may be communicably coupled to the one or more wireline tools 132 by way of the cable 142. The computing facilities 138 may comprise an information handling system, for example, information handling system 400 of FIG. 4. In one or more embodiments, the lithology prediction may be generated by using the computing facilities 138. Alternatively, the well log data gathered by the one or more wireline tools 132 may be transmitted (wired or wirelessly) or physically delivered to computing facilities off-site where the lithology prediction is generated by a remote information handling system, for example, information handling system 400 of FIG. 4.

FIG. 1C depicts a schematic partial cutaway view of a wellbore environment 160 for acquiring data for use in a lithology prediction using a machine learning model. The wellbore environment 160 may comprise one or more derricks 102 positioned or located at or about an area of interest. Any one or more of the one or more derricks 102 may comprise a wireline or cable 142 that suspend a wireline tool 132. The wireline or cable 142 may be unspooled to a downhole location within wellbore 108 via logging facility 136. The logging facility 136 may comprise computing facilities 138 which may include an on-board communication system or control system such as an information handling system 400 of FIG. 4. The computing facilities 138 may transmit data received from the one or more sensors 133 of the wireline tool 132. The data may be transmitted to the data acquisition unit 128 wired or wirelessly. Wireline tool 132 may comprise one or more sensors 133. The one or more sensors 133 may detect various properties of the wellbore 108 and surrounding areas within the subterranean formation 130. The one or more sensors 133 may comprise any one or more of gamma ray sensors, resistivity sensors, acoustic sensors, nuclear sensors (for example, neutron porosity and bulk density), and any other suitable sensor. The one or more sensors 133 may be used to detect one or more properties of the subterranean formation 130 through which the one or more wellbores 108 are drilled. One or measurements taken by the one or more sensors 133 may relate to subsurface locations close to the wellbore 108, for example, “near field.”

In one or more embodiments, data acquisition unit 128 may comprise a two-dimensional (2-D), three-dimensional (3-D) or four-dimensional (4-D) seismic data collection system, for example, an information handling system 400 of FIG. 4, used to collect seismic data within the post-stack seismic reflection volume of the subterranean formation 130 where one or more wellbores 108 are drilled. In one or more embodiments, the data acquisition unit 128 may comprise a machine learning algorithm used for generated a lithology prediction for an area of interest. In one or more embodiments, the data acquisition unit 128 may comprise any combination of a control system 129 and one or more seismic source transmitters 127. The data acquisition system 128 may receive data from various components at or about the wellbore environment 160 including but not limited to an array of or one or more receivers (for example, geophones) 134 located at spaced intervals about the well system 160, one or more sensors 133, or both. In one or more embodiments, the one or more receivers 134 may be equidistantly spaced from each other and arranged in a grid. The area of interest in which the one or more receivers 134 are located may range from a few square miles to as large as hundreds of square miles or more. The one or more source transmitters 127 may include any type of seismic source used to send sound waves down into the reservoir or subterranean formation 130. In one or more embodiments, the one or more source transmitters 127 may include a “thumper” that drops a large weight on the ground or surface to send sound waves down into the reservoir or subterranean formation 130 at an angle. The sound waves recorded by the one or more receivers 134 (for example, one or more geophones) will generally change while propagating through the reservoir or subterranean formation 130 due to the change in subterranean formations 130. The sound waves are reflected back at particular angles and picked up by the array of or the one or more receivers 134. The 2-D, 3-D or 4-D seismic data received at the one or more receivers 134 may be transmitted via a communication system from the one or more receivers 134 to a control system 129. Control system 129 may comprise one or more information handling systems, for example, information handling system 400 of FIG. 4. In one or more embodiments, control system 129 and any one or more transmitters 127 may be within or communicatively coupled to the data acquisition unit 128. The one or more transmitters 127 may be moved to different locations along the survey to transmit sound waves into the reservoir or subterranean formation 130 from various different angles. The one or more receivers 134 may detect changes in the reflected sound waves at different positions of the source 134 to determine seismic horizons related to a reservoir or subterranean formation 130. The seismic data may provide a measurement of the quality of layers in the subsurface 2-D, 3-D or 4-D post-stack seismic reflection volume.

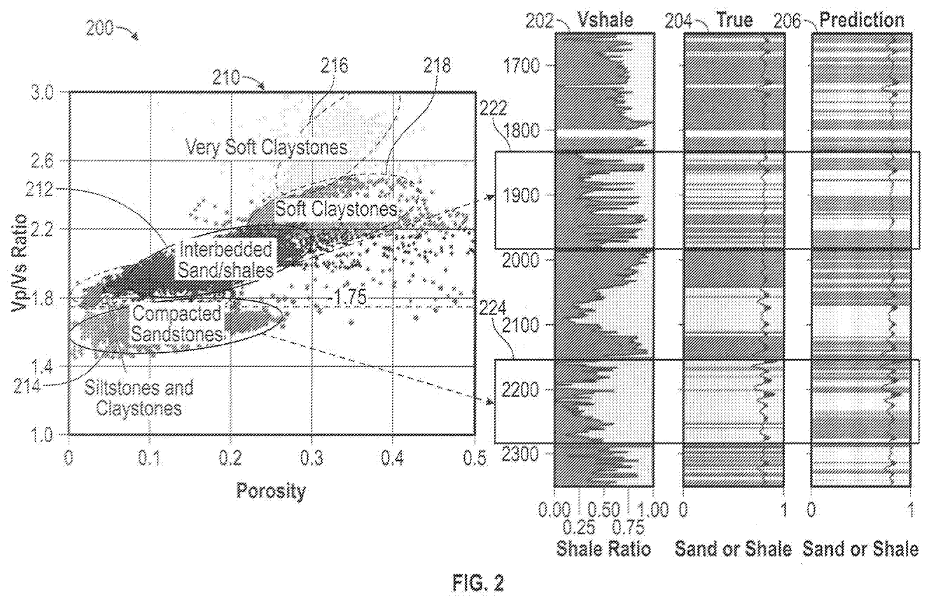

A key challenge to predicting lithology in seismic data is that the same lithology can have different physical properties downhole, due to factors such as diagenesis and fluid content so that the same lithology can have a different seismic expression. FIG. 2 is a cross-plot of data associated with a subterranean formation and corresponding lithology prediction 200. FIG. 2 illustrates on the left a cross-plot 210 of seismic data associated with subterranean formation of an area of interest with the y-axis corresponding to the velocity of seismic waves through the subterranean formation and the x-axis corresponding to the porosity of the subterranean formation where Vp is the velocity of the primary wave and Vs is the shear wave. The cross-plot illustrates a first formation area 212 of interbedded sand, shale or both, a second formation area 214 of compacted sandstone, a third formation area 216 of very soft claystone and a fourth formation area of soft claystone 218. To the right of the cross-plot 210 at column 202 is a graph of a volume of shale in a subterranean formation associated with a post-stack seismic reflection volume of an area of interest, at column 204 is a representation of observations of a test data set and at column 206 is a lithology prediction using known mechanisms. The data at 222 corresponds to the data at 212 of cross-plot 200 while the data at 224 corresponds to the data at 214 of cross-plot 200. As can be seen in FIG. 2, the predicted lithology of column 206 does not provide satisfactory results when viewed against column 204 due to the differing physical properties of the same lithology with depth.

The present inventions solves the problems associated with known lithology prediction mechanisms by utilizing a robust lithology prediction model. The lithology prediction model requires at least four data sets comprising a post-stack seismic reflection volume (two-dimension (2-D), three-dimensional (3-D) or four-dimensional (4-D), a geophysical age model with the same dimensions as the post-stack seismic reflection volume, one or more wellbores with lithology labels and calibrated TWT-depth relationships to ensure the one or more wellbores can be tied to the post-stack seismic reflection volume. As a 4-D post-stack seismic reflection volume is the same as a 3-D post-stack seismic reflection volume except that the 4-D post-stack seismic reflection volume includes a time component through multiple stages of acquisition, a reference throughout to 3-D post-stack seismic reflection volume refers to both 3-D and 4-D post-stack seismic reflection volumes. The present disclosure contemplates that two types of seismic are of interest. A regional post-stack seismic reflection survey or volume is sampled coincident with the well or wellbore sampling to train a machine learning model and used to make the volumetric prediction. Also, a vertical seismic profiling or surveying at the wellbore system or environment can be used to define and calibrate the TWT-depth relationship that then allows the well log or core data recorded in depth to be calibrated against the post-stack reflection seismic volume recorded in TWT or vice-versa.

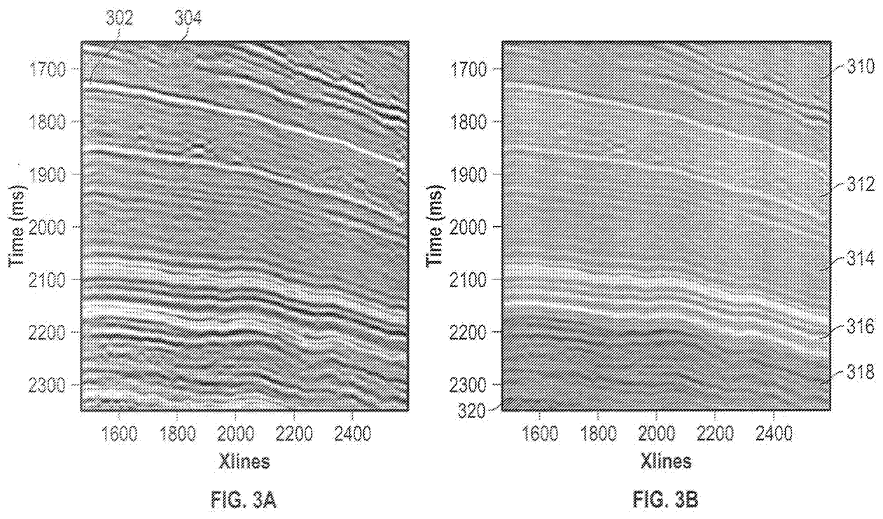

A geophysical age model provides the geological context based on which the seismic characters of a subterranean formation of an area of interest can be differentiated and then learned in a consistent way by a machine learning model. Using a geophysical age model improves the lithology prediction as the same lithology can have different physical properties downhole due to the action of diagenesis and fluid content. Additionally, the geophysical age model provides the lateral constraint to consistently interpret the seismic response corresponding to a given lithology variation at a particular geophysical age or geophysical interval throughout the post-stack seismic reflection volume. Training the machine learning model based on the geophysical age model results in the reduction of uncorrelated noise and allows geologically realistic geological bodies (for example, parasequences and progradation trends) to be observable from the lithology prediction results. The geophysical age model is generated based on a selection and mapping of a plurality of seismic horizons present within the seismic data of the post-stack seismic reflection volume. For example, FIG. 3A illustrates seismic horizons, including seismic horizons 302 within seismic data 304 associated with a post-stack seismic reflection volume or a section through the post-stack seismic reflection volume. FIG. 3B illustrates geophysical age modelling defined by the seismic horizons of FIG. 3A. The seismic horizons within the post-stack seismic reflection volume allow discrete seismic packages, 310, 312, 314, 316, 318 and 320) to be identified. For example, package 314 is “older” than package 312. The values that define the geophysical age model may represent the true absolute geological age, a smoothly varying arbitrary estimate of relative age, discrete labelling of the seismic packages, or any combination thereof so long as the geophysical age model is capable of separating and recording different seismic packages derived from the seismic horizon interpretation and takes into consideration the seismic reflectors. The seismic horizon interpretation on which the geophysical age model is based may be generated manually, using automated tracking techniques or using one or more techniques that generate a dense seismic horizon interpretation.

Well log data, well core data, chippings data, any other suitable data or any combination thereof is collected for one or more wellbores within the post-stack seismic reflection volume of an area of interest, for example, well log data collected as discussed with respect to FIGS. 1A and 1B. A lithology interpretation is obtained from the petrophysical analysis of this log and core data, augmented by chippings information. The lithology interpretation may be conducted manually, by leveraging automated interpretation techniques, any one or more different techniques, and any combination thereof. To allow the multivariate model to learn the seismic expression of different lithologies, the one or more wellbores within the post-stack seismic reflection volume are accurately tied to the seismic by utilizing calibrated TWT-depth relationship for each of the one or more wellbores. In one or more embodiments, to minimize uncertainties associated with depth converting the entire post-stack seismic reflection volume, the lithology prediction is conducted in the seismic TWT domain. In one or more embodiments, the lithology prediction is made directly in the depth domain, for example, when the seismic data has been pre-stack depth migrated. Even when directly using the depth domain, accuracy is improved by validating ties between the wellbores and the seismic data.

A supervised machine learning approach is used to train a multivariate model or a machine learning model to recognize the link between the post-stack seismic reflection volume and the obtained lithology interpretation. The machine learning model is trained using at least one one-dimensional (1-D) seismic trace and a 1-D geophysical age trace extracted from post-stack seismic reflection volume and geophysical age model, respectively, along each well where the 2-D and 3-D seismic data comprise a plurality of one-dimensional traces. In one or more embodiments, the 1-D seismic trace and 1-D geophysical age trace may be extracted along the wellbore path if required. In one or more embodiments, one or more 1-D seismic traces along, adjacent to or otherwise associated with any one or more wells or wellbores are extracted from a 2-D post-stack seismic reflection volume or a 3-D post-stack seismic reflection volume and geophysical age model to train a multivariate model or machine learning model. In one or more embodiments, one or more 2-D sub-sections or 3-D sub-volumes adjacent to, intersecting or otherwise associated with any one or more wells or wellbores are extracted from a post-stack seismic reflection volume and geophysical age model around the one or more wells or wellbores to train a multivariate model or machine learning model. Due to the different sampling intervals of seismic data and well log and well core data in addition to the potentially non-linear TWT-depth relationship used to match seismic to a particular wellbore then down-sampling, up-sampling, interpolation and any combination thereof is necessary to ensure that the post-stack seismic reflection volume, geophysical age model and the lithology interpretation from a selected well or wellbore have the same sampling intervals and are truly coincident. The machine learning model learns the relationships between the seismic trace geophysical age trace (the 1-D equivalent of the seismic trace but derived from the geophysical age model) and the lithology labels present in the wellbore so that the machine learning model is capable of outputting a 1-D prediction of lithology at any point within the seismic data. In one or more embodiments, the machine learning model is trained using the random forest method or an ensemble learning method based on a decision tree.

In one or more embodiments, the machine learning model is trained to minimize classification error as shown in Equation 1.

$${min}_{ϵ} ( {L}_{i j} - f ( {A}_{i k} , {R}_{i m )} ) \qquad Equation 1$$

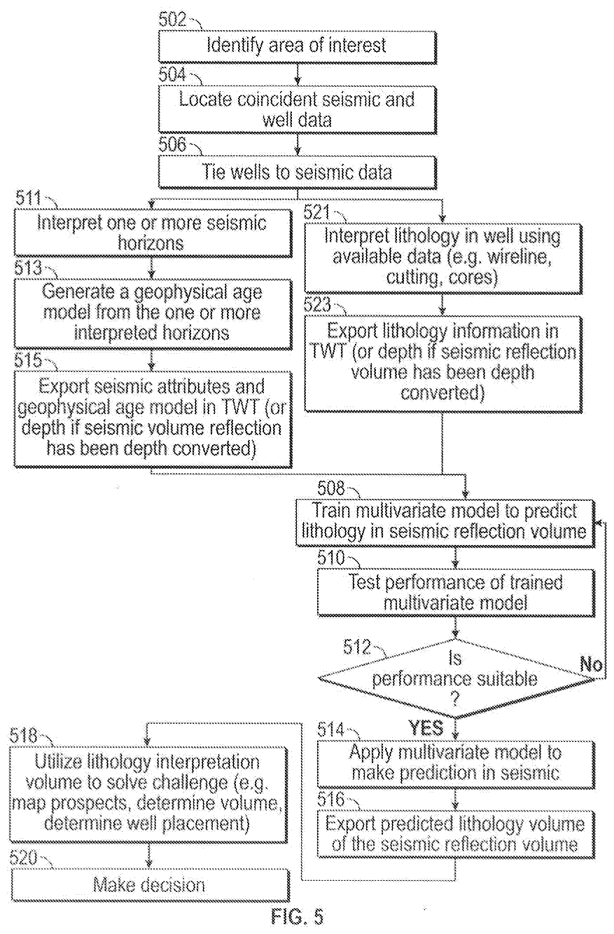

In Equation 1, ∈ a classification loss function, including but not limited to differentiable f1 score, cross-entropy loss, hinge, Kullback Leibler divergence loss for the training of the machine learning model, Lᵢⱼ is an exported lithology at TWT or depth j in well i (for example, as discussed with respect to step 523 of FIG. 5), that is generated from a derived or interpreted lithology information (for example, as discussed with respect to step 523 of FIG. 5), ƒ( ) is a supervised machine learning model that may, for example, include feature engineering steps to derive attributes or features from the input post-stack seismic reflection volume and the geophysical age model of step 513 of FIG. 5, Aᵢₖ represents a seismic attribute associated with a post-stack seismic reflection volume coincident with well i over a TWT (or depth) window k where

k=j−τ₁,j−τ₁+δ, . . . j+τ₁,

τ₁=half width of the window

δ=sample spacing

and Rᵢₘ, is a geophysical age model, for example, the geophysical age model of Step 513 of FIG. 5, derived from an interpretation of seismic horizons coincident with a selected well or wellbore i of an area of interest, for example, over a TWT (or depth) window m, where

m=j−τ₂,j−τ₂+δ, . . . j+τ₂

τ₂=half width of the window.

In one or more embodiments, any one or more other terms or inputs may be utilized with Equation 1, for example, a regularization term may be used to ensure convergence and a satisfactory resulting machine learning model.

Once the machine learning model has been trained, the machine learning model may be validated or performance tested against data, for example, wellbore data that was not used for training of the machine learning model. Such validation measures the quality of the lithology prediction. If the quality of the machine learning model is determined to be at or below a threshold, the machine learning model may be re-trained by, for example, including different seismic attributes associated with the seismic data (such as instantaneous phase, instantaneous frequency, instantaneous power, analytic signal, AVO (amplitude versus offset) attributes, coherence, impedance, similarity, discontinuity, sweetness, curvature and continuous wavelet transform, modifying the geophysical age model (such as by refining the interpretation of seismic horizons or window size), refinement of tying the one or more wells or wellbores to the seismic data, modifying the lithology interpretation within the wellbores by using a detailed petrophysical analysis compared to a more automated approach or by using additional data (for example, cuttings or other well or wellbore data that was not used in or available for the initial interpretation), adjusting hyperparameters, architecture or algorithm used by the machine learning model, and any combination thereof. Once the machine learning model is validated, for example, a quality value or performance value determined for the machine learning model is at or above a threshold, the machine learning model may be used to predict a lithology variation in 2-D or 3-D of a subterranean formation of an area of interest using the post-stack seismic reflection volume and geological age model. Since the machine learning model is trained and tested in 1-D, the seismic trace, (from the one or more wellbores), the 2-D/3-D lithology model is essentially accomplished by utilizing the machine learning model to make predictions on each seismic trace in the post-stack seismic reflection volume in series, in parallel or both to generate a predicted lithology volume.

FIG. 4 is a diagram illustrating an example information handling system 400, for example, for use with or by an associated wellbore system 100 of FIG. 1, according to one or more aspects of the present disclosure. The computing subsystem 110 of FIG. 1 may take a form similar to the information handling system 400. A processor or central processing unit (CPU) 401 of the information handling system 400 is communicatively coupled to a memory controller hub (MCH) or north bridge 402. The processor 401 may include, for example a microprocessor, microcontroller, digital signal processor (DSP), application specific integrated circuit (ASIC), or any other digital or analog circuitry configured to interpret and/or execute program instructions and/or process data. Processor 401 may be configured to interpret and/or execute program instructions or other data retrieved and stored in any memory such as memory 403 or hard drive 407. Program instructions or other data may constitute portions of a software or application, for example application 458 or data 454, for carrying out one or more methods described herein. Memory 403 may include read-only memory (ROM), random access memory (RAM), solid state memory, or disk-based memory. Each memory module may include any system, device or apparatus configured to retain program instructions and/or data for a period of time (for example, non-transitory computer-readable media). For example, instructions from a software or application 458 or data 454 may be retrieved and stored in memory 403 for execution or use by processor 401. In one or more embodiments, the memory 403 or the hard drive 407 may include or comprise one or more non-transitory executable instructions that, when executed by the processor 401 cause the processor 401 to perform or initiate one or more operations or steps. The information handling system 400 may be preprogrammed or it may be programmed (and reprogrammed) by loading a program from another source (for example, from a CD-ROM, from another computer device through a data network, or in another manner).

The data 454 may include treatment data, geological data, fracture data, seismic or micro seismic data, or any other appropriate data. In one or more embodiments, a memory of a computing device includes additional or different data, application, models, or other information. In one or more embodiments, the data 454 may include geological data relating to one or more geological properties of the subterranean formation 130. For example, the geological data may include information on the wellbore 108, completions, or information on other attributes of the subterranean formation 130. In one or more embodiments, the geological data includes information on the lithology, fluid content, stress profile (for example, stress anisotropy, maximum and minimum horizontal stresses), pressure profile, spatial extent, or other attributes of one or more rock formations in the subterranean zone. The geological data may include information collected from well logs, rock samples, outcroppings, seismic or microseismic imaging, or other data sources.

The one or more applications 458 may comprise one or more software applications, one or more scripts, one or more programs, one or more functions, one or more executables, or one or more other modules that are interpreted or executed by the processor 401. For example, the one or more applications 458 may include a machine learning model for lithology prediction, a seismic interpretation model, a geophysical age model, fracture design module, a reservoir simulation tool, a hydraulic fracture simulation model, or any other appropriate function block, module, model or application. The one or more applications 458 may include machine-readable instructions for performing one or more of the operations related to any one or more embodiments of the present disclosure. The one or more applications 458 may include machine-readable instructions for generating a user interface or a plot, for example, lithology properties, for example, as illustrated in FIGS. 2, 3A, 3B, 6A, 6B and 6C. The one or more applications 458 may obtain input data, such as seismic data, well data, treatment data, geological data, fracture data, or other types of input data, from the memory 403, from another local source, or from one or more remote sources (for example, via the one or more communication links 414). The one or more applications 458 may generate output data and store the output data in the memory 403, hard drive 407, in another local medium, or in one or more remote devices (for example, by sending the output data via the communication link 414).

Modifications, additions, or omissions may be made to FIG. 4 without departing from the scope of the present disclosure. For example, FIG. 4 shows a particular configuration of components of information handling system 400. However, any suitable configurations of components may be used. For example, components of information handling system 400 may be implemented either as physical or logical components. Furthermore, in some embodiments, functionality associated with components of information handling system 400 may be implemented in special purpose circuits or components. In other embodiments, functionality associated with components of information handling system 400 may be implemented in configurable general purpose circuit or components. For example, components of information handling system 400 may be implemented by configured computer program instructions.

Memory controller hub 402 may include a memory controller for directing information to or from various system memory components within the information handling system 400, such as memory 403, storage element 406, and hard drive 407. The memory controller hub 402 may be coupled to memory 403 and a graphics processing unit (GPU) 404. Memory controller hub 402 may also be coupled to an I/O controller hub (ICH) or south bridge 405. I/O controller hub 405 is coupled to storage elements of the information handling system 400, including a storage element 406, which may comprise a flash ROM that includes a basic input/output system (BIOS) of the computer system. I/O controller hub 405 is also coupled to the hard drive 407 of the information handling system 400. I/O controller hub 405 may also be coupled to an I/O chip or interface, for example, a Super I/O chip 408, which is itself coupled to several of the I/O ports of the computer system, including a keyboard 409, a mouse 410, a monitor 412 and one or more communications link 414. Any one or more input/output devices receive and transmit data in analog or digital form over one or more communication links 414 such as a serial link, a wireless link (for example, infrared, radio frequency, or others), a parallel link, or another type of link. The one or more communication links 414 may comprise any type of communication channel, connector, data communication network, or other link. For example, the one or more communication links 414 may comprise a wireless or a wired network, a Local Area Network (LAN), a Wide Area Network (WAN), a private network, a public network (such as the Internet), a wireless fidelity or WiFi network, a network that includes a satellite link, or another type of data communication network.

FIG. 5 illustrates a flow chart for a lithology prediction using a geophysical age model according to one more aspects of the present invention. At step 502, an area of interest is identified. For example, an area at a surface or subsea may be identified based, at least in part, on one or more current, previous or prospective well environments, a formation or rock type, any other criteria associated with an operation, and any combination thereof.

At step 504, post-stack seismic reflection volume data (seismic data) and well data within the area of interest and one or more wells are identified. This may be data that the user already possesses (e.g. stored on a hard drive or server) or it may need to be acquired or purchased. Once the seismic data are identified, it is then necessary to identify well data that intersect some part of the seismic data to locate coincident seismic data and well data. This step may be achieved using computer software, on a map or any other media. At step 506, the one or more wells identified at step 504 for the area of interest are tied to seismic data associated collected over a period of time for the identified area of interest.

After step 506, steps 511-515 and 521-523 may be performed simultaneously or sequentially. At step 511, one or more seismic horizons present within the seismic data of the post-stack seismic reflection volume within the identified area of interest are interpreted. At step 513, a geophysical age model is generated from the one or more seismic horizon interpretations. At step 515, at least one of one or more seismic attributes and the geophysical age model are exported, for example, in TWT or depth if post-stack seismic reflection volume has been depth converted for use by the multivariate model or the machine learning model.

At step 521, collected historical or real-time lithology data of the subsurface or subterranean formations that the well intersects as the well is drilled are interpreted using available data (for example, wireline core and cuttings data) from the one or more wells identified from step 502. Available data may comprise any one or more of well log or core data, wireline data, cutting data, and any combination thereof. At step 523, lithology information interpreted or derived at step 521 in TWT or depth if post-stack seismic reflection volume that has been depth converted is exported.

At step 508, in one or more embodiments, a multivariate model or machine learning model is trained to predict a lithology volume by any one or more of using an individual or one or more 1-D seismic traces coincident or intersecting with a well or a wellbore of a 2-D post-stack seismic reflection volume or a 3-D post-stack seismic reflection volume along with a geophysical age model, using a 2-D sub-section of a 2-D or 3-D post-stack seismic reflection volume intersecting the well or wellbore or surrounding the well or wellbore along with a geophysical age model, and using a 3-D sub-volume adjacent to, intersecting or otherwise associated with the well or wellbore with a geophysical age model where the exports from 515 and 523 are inputs, for example, as discussed with respect to Equation 1.

At step 510, the performance of the trained multivariate model or machine learning model is tested. At step 512, a determination is made as to the suitability of performance of the trained multivariate model or machine learning model. For example, at Step 510 a quality value or performance value is determined for the trained multivariate model or machine learning model. The quality value or performance value may be compared to a threshold and based on that comparison the method proceeds to either step 514 or back to step 508. In one or more embodiments, if the performance (such as the quality value or the performance value) of the multivariate model or machine learning model is found to be at a threshold, above a threshold or both, the method proceeds to step 514. If the performance of the multivariate model is below or at or below a threshold, the method proceeds to step 508 to conduct feature engineering before retraining the multivariate model or machine learning model. In one or more embodiments, alternative modelling techniques may also be used at this stage.

At step 514, the multivariate model or machine learning model is applied to generate a lithology prediction using the entire post-stack seismic reflection volume and geophysical age model as inputs to generate a predicted lithology volume.

In one or more embodiments, the multivariate model or the machine learning model is used to predict lithology volume as shown in Equation 2.

\hat{L}ₜⱼ=ƒ(Aₜₖ, Rₜₘ) Equation 2

In Equation 2, \hat{L}ₜⱼ is the predicted lithology at TWT (or depth) j for seismic trace t in the post-stack seismic reflection volume, ƒ( ) is a supervised machine learning model that may, for example, include feature engineering steps to derive attributes or features from the input post-stack seismic reflection volume and the geophysical age model of step 513 of FIG. 5, Aₜₖ represents a seismic attribute associated with a post-stack seismic reflection volume for trace t over a TWT (or depth) window k where

k=j−τ₁,j−τ₁+δ, . . . j+τ₁,

τ₁=half width of the window

δ=sample spacing

and Rₜₘ, is a geophysical age model, for example, the geophysical age model of Step 513 of FIG. 5, derived from an interpretation of seismic horizons for trace t over a TWT (or depth) window m, where τ₁ and τ₂ are the same as discussed with respect to Equation 1 and where

m=j−τ₂,j−τ₂+δ, . . . j+τ₂

τ₂=half width of the window.

In one or more embodiments, any one or more other terms or inputs may be utilized with Equation 2.

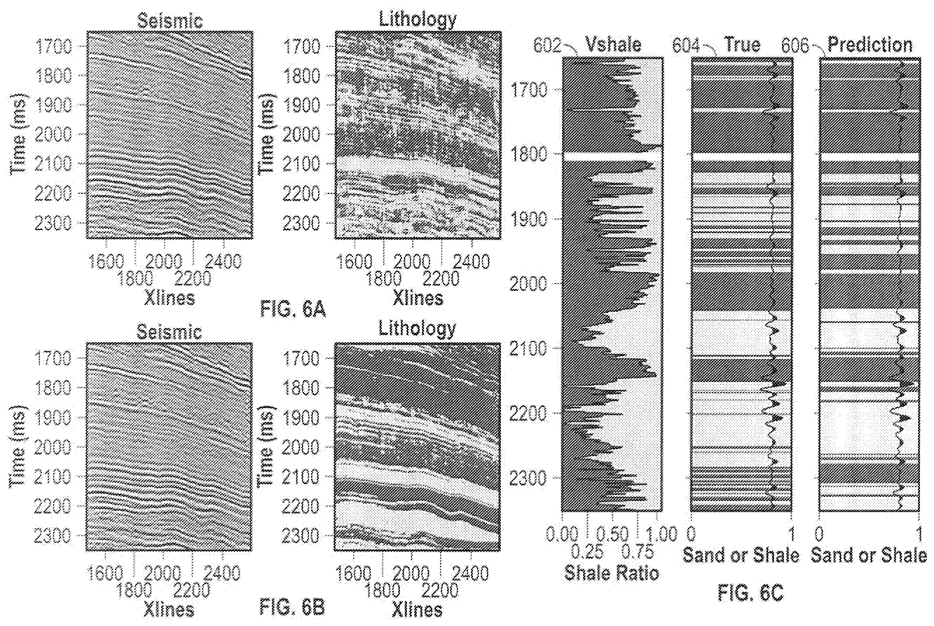

At step 516, the predicted lithology volume generated in step 514 is exported for use in a software environment. At step 518, the predicted lithology volume is utilized to determine a workflow or operation, for example, to solve a challenge. For example, the predicted lithology volume may be utilized to map one or more prospective wells or well environments, determine volume of potential reservoirs of hydrocarbons, water, CO₂ or other rocks and fluids of an area of interest, determine placement of a well or wellbore at a well environment, generate a plot, for example, as discussed with respect to FIG. 6C, any other operation and any combination thereof. At step 520, a decision is made as to the specific operation to perform.

As discussed with respect to FIG. 5, the robust multivariate model or machine learning model trained to predict lithology using both the seismic reflection volume and a geophysical age model produces a more accurate predicted lithology volume of a subterranean formation associated with a post-stack seismic reflection volume of an area of interest. FIG. 6A illustrates a predicted lithology volume using known techniques that do not utilize a geophysical age model. The plot on the left of FIG. 6A illustrates a section extracted from a seismic reflection volume for a given subterranean formation associated with a selected post-stack seismic reflection volume of an area of interest. The plot on the right of FIG. 6A illustrates a lithology prediction based on the post-stack seismic reflection volume as a training data set without utilizing a geophysical age model. FIG. 6B illustrates a lithology prediction using the trained multivariate model or machine learning model discussed herein, for example, with respect to FIG. 5. The plot on the left of FIG. 6B is the same as that found in FIG. 6A. The plot on the right of FIG. 6B illustrates the robust lithology prediction based on a geophysical age model, for example, as discussed with respect to FIG. 5. The lithology prediction of FIG. 6B is a more geologically reasonable prediction than the lithology prediction of FIG. 6A. FIG. 6C illustrates at column 602 a graph of a volume of shale in the subterranean formation associated with a post-stack seismic reflection volume of an area of interest, column 604 illustrates a test data set and column 606 illustrates a plot of a lithology prediction utilizing a geophysical age model. As shown in FIG. 6C, the lithological bodies of FIG. 6B are better defined, more laterally continuous and demonstrated a better agreement with the test data 604 than the lithology prediction of FIG. 6A. For example, a comparison of FIG. 6C with FIG. 2 show the improvement of lithology prediction using the trained multivariate model or machine learning model that takes into consideration a geophysical age model as compared to other techniques that do not.

While one or more aspects of the present disclosure are discussed with respect to seismic data associated with a wellbore environment, the present disclosure contemplates that one or more embodiments may comprise utilizing one or more steps of FIGS. 5A and 5B with geospatial imaging, for example.

In one or more embodiments, a lithology prediction method comprises identifying an area of interest at a site, wherein a post-stack seismic reflection volume is associated with the area of interest, locating coincident seismic data associated with the post-stack seismic reflection volume and well data associated with one or more wellbores in the area of interest, tying the seismic data to the one or more wellbores, generating a geophysical age model associated with the post-stack seismic reflection volume, training a machine learning model based, at least in part, on the geophysical age model and generating a predicted lithology volume based, at least in part, on the machine learning model. In one or more embodiments, the method further comprises interpreting one or more seismic horizons associated with the post-stack seismic reflection volume, wherein the geophysical age model is generated based, at least in part, on the one or more interpreted seismic horizons. In one or more embodiments, the method further comprises exporting at least one of one or more seismic attributes associated with the post-stack seismic reflection volume and the geophysical age model for training the machine learning model. In one or more embodiments, the method further comprises interpreting a lithology of a formation within the area of interest using the seismic data and the well data. In one or more embodiments, the method further comprises exporting lithology information associated with the lithology. In one or more embodiments, the method further comprises altering one or more operations at the area of interest based, at least in part, on the predicted lithology volume. In one or more embodiments, the method further comprises determining a performance value of the machine learning model, comparing the performance value to a threshold, retraining the machine learning model based on the comparison of the performance value to the threshold.

In one or more embodiments, A non-transitory computer readable storage medium storing one or more instructions, that when executed by a processor, cause the processor to perform any one or more of the above method steps.

In one or more embodiments, an information handling system comprises a memory, a processor coupled to the memory, wherein the memory comprises one or more instructions executable by the processor to perform any one or more of the above method steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

A number of examples have been described. Nevertheless, it will be understood that various modifications can be made. For example, any one or more steps of FIG. 5 may be performed simultaneously, substantially simultaneous, in any order, or not at all. Accordingly, other implementations are within the scope of the following claims.

What is claimed is:

1. A lithology prediction method, comprising:
identifying an area of interest at a site, wherein a post-stack seismic reflection volume is associated with the area of interest;
locating coincident seismic data associated with the post-stack seismic reflection volume and well data associated with one or more wellbores in the area of interest;
tying the seismic data to the one or more wellbores;
generating a geophysical age model associated with the post-stack seismic reflection volume;
training a machine learning model based, at least in part, on the geophysical age model; and
generating a predicted lithology volume based, at least in part, on the machine learning model.

2. The method of claim 1, further comprising:
interpreting one or more seismic horizons associated with the post-stack seismic reflection volume, wherein the geophysical age model is generated based, at least in part, on the one or more interpreted seismic horizons.

3. The method of claim 1, further comprising:
exporting at least one of one or more seismic attributes associated with the post-stack seismic reflection volume and the geophysical age model for training the machine learning model.

4. The method of claim 1, further comprising:
interpreting a lithology of a formation within the area of interest using the seismic data and the well data.

5. The method of claim 4, further comprising:
exporting lithology information associated with the lithology.

6. The method of claim 1, further comprising:
altering one or more operations at the area of interest based, at least in part, on the predicted lithology volume.

7. The method of claim 1, further comprising:
determining a performance value of the machine learning model;
comparing the performance value to a threshold; and
retraining the machine learning model based on the comparison of the performance value to the threshold.

8. A non-transitory computer readable storage medium storing one or more instructions, that when executed by a processor, cause the processor to:
identify an area of interest at a site, wherein a post-stack seismic reflection volume is associated with the area of interest;
locate coincident seismic data associated with the post-stack seismic reflection volume and well data associated with one or more wellbores in the area of interest;
tie the seismic data to the one or more wellbores;
generate a geophysical age model associated with the post-stack seismic reflection volume;
train a machine learning model based, at least in part, on the geophysical age model; and
generate a predicted lithology volume based, at least in part, on the machine learning model.

9. The non-transitory computer readable storage medium of claim 8, wherein the one or more instructions, that when executed by the processor, further cause the processor to:
interpret one or more seismic horizons associated with the post-stack seismic reflection volume, wherein the geophysical age model is generated based, at least in part, on the one or more interpreted seismic horizons.

10. The non-transitory computer readable storage medium of claim 8, wherein the one or more instructions, that when executed by the processor, further cause the processor to:
export at least one of one or more seismic attributes associated with the post-stack seismic reflection volume and the geophysical age model for training the machine learning model.

11. The non-transitory computer readable storage medium of claim 8, wherein the one or more instructions, that when executed by the processor, further cause the processor to:
interpret a lithology of a formation within the area of interest using the seismic data and the well data.

12. The non-transitory computer readable storage medium of claim 11, wherein the one or more instructions, that when executed by the processor, further cause the processor to:
export lithology information associated with the lithology.

13. The non-transitory computer readable storage medium of claim 8, wherein the one or more instructions, that when executed by the processor, further cause the processor to:
alter one or more operations at the area of interest based, at least in part, on the predicted lithology volume.

14. The non-transitory computer readable storage medium of claim 8, wherein the one or more instructions, that when executed by the processor, further cause the processor to:
determine a performance value of the machine learning model;
compare the performance value to a threshold; and
retrain the machine learning model based on the comparison of the performance value to the threshold.

15. An information handling system comprising:
a memory;
a processor coupled to the memory, wherein the memory comprises one or more instructions executable by the processor to:
identify an area of interest at a site, wherein a post-stack seismic reflection volume is associated with the area of interest;
locate coincident seismic data associated with the post-stack seismic reflection volume and well data associated with one or more wellbores in the area of interest;
tie the seismic data to the one or more wellbores;
generate a geophysical age model associated with the post-stack seismic reflection volume;
train a machine learning model based, at least in part, on the geophysical age model; and
generate a predicted lithology volume based, at least in part, on the machine learning model.

16. The information handling system of claim 15, wherein the one or more instructions are further executable by the processor to:
interpret one or more seismic horizons associated with the post-stack seismic reflection volume, wherein the geophysical age model is generated based, at least in part, on the one or more interpreted seismic horizons.

17. The information handling system of claim 15, wherein the one or more instructions are further executable by the processor to:
export at least one of one or more seismic attributes associated with the post-stack seismic reflection volume and the geophysical age model for training the machine learning model.

18. The information handling system of claim 15, wherein the one or more instructions are further executable by the processor to:
interpret a lithology of a formation within the area of interest using the seismic data and the well data.

19. The information handling system of claim 15, wherein the one or more instructions are further executable by the processor to:
alter one or more operations at the area of interest based, at least in part, on the predicted lithology volume.

20. The information handling system of claim 15, wherein the one or more instructions are further executable by the processor to:
determine a performance value of the machine learning model;
compare the performance value to a threshold; and
retrain the machine learning model based on the comparison of the performance value to the threshold.
